(19) United States
(12) Patent Application Publication
(10) Pub. No.: US 2010/0241647 A1
(43) Pub. Date: Sep. 23, 2010

(54) Context-Aware Query Recommendations

(75) Inventors: Alexandros Ntoulas, Mountain view, CA (US); Heasoo Hwang, La Jolla, CA (US); Lise C. Getoor, Takoma Park, MD (US); Stelios Paparizos, San Jose, CA (US); Hady Wirawan Lauw, Mountain view, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/408,726

(22) Filed: Mar. 23, 2009

(51) Int. Cl. G06F 17/30

(52) U.S. Cl. 707/765; 707/E17.014; 707/E17.03

(57) ABSTRACT

Described is a search-related technology in which context information regarding a user's prior search actions is used in making query recommendations for a current user action, such as a query or click. To determine whether each set or subset of context information is relevant to the user action, data obtained from a query log is evaluated. More particularly, a query transition (query-query) graph and a query click (query-URL) graph are extracted from the query log; vectors are computed for the current action and each context/sub-context and evaluated against vectors in the graphs to determine current action-to-context similarity. Also described is using similar context to provide the query recommendations, using parameters to control the similarity strictness, and/or whether more recent context information is more relevant than less recent context information, and using context information to distinguish between user sessions.

### BACKGROUND

When searching for information online, users do not always specify their queries in the best possible way with respect to finding desired results. When desired results are not apparent, users sometimes click on relevant query recommendations (also known as query suggestions, query refinements or related searches) to refine or otherwise adjust their search activity.

Current technology provides such a query recommendation service that is based upon analyzing each current query, but this technology does not always provide query recommendations that are relevant. Irrelevant query recommendations do not benefit users, and may lead to a user employing a different search engine. Any technology that provides more relevant query recommendations to users is valuable to those users, as well as to the search engine company that provides the query recommendations.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which context information regarding prior search actions of a user is maintained, and used in making query recommendations following a current user action such as a query or click. To determine whether context information is relevant to the user action, data obtained from a query log, e.g., in the form of a query transition (query-query) graph and a query click (query-URL) graph are accessed. For example, vectors may be computed for the current action and each context/sub-context and evaluated against vectors in the graphs to determine current action-to-context similarity.

In one aspect, parameters may be used to control whether the context information is considered relevant to the current action, and/or whether more recent context information is more relevant than less recent context information with respect to the current action. In another aspect, the context information may be analyzed to distinguish between user sessions.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components in a search environment/architecture that provides context-aware query recommendations.

FIG. 2 is a representation showing a small portion of an example query transition (query-query) graph used in providing context-aware query recommendations.

FIG. 3 is a representation showing a small portion of an example query click (query-URL) graph used in providing context-aware query recommendations.

FIG. 4 is a flow diagram showing example steps that may be taken in online processing of a query to provide context-aware query recommendations.

FIG. 5 shows an illustrative example of a computing environment into which various aspects of the present invention may be incorporated.

### DETAILED DESCRIPTION

Various aspects of the technology described herein are generally directed towards determining which queries and/or clicks from a user's search history (previous queries and/or clicks) are related to the user's current query, that is, form the context of the current query. This context determination is then useful in determining query recommendations to return to the user in response to the query, e.g., included on a results page.

In one implementation, an online algorithm/mechanism computes the similarity of the current query to context data determined from the user's history. As described below, one approach involves constructing a query transition (query-query) graph and a query click (query-URL) graph from a search engine's query log, locating the current query and the user's history in the graphs, and computing the similarity between the current query and any previously identified contexts in order to determine the most relevant context to use for the current query. Also described is an algorithm/mechanism for generating query recommendations that are relevant to the identified context. For this, query recommendations are generated around the identified context using the same query transition graph.

It should be understood that any of the examples described herein are non-limiting examples. For example, data and/or data structures other than query-query graph and query-URL graph may be used instead of or in addition to those described to obtain context. Similarly, other algorithms instead of or in addition to those described may be used.

Moreover, while the examples herein are directed towards query recommendations, however it is understood that query recommendations encompasses the concept of advertisements. Thus, for example, the technology described herein may be used to return context-aware advertisements, instead of or in addition to what is understood to be traditional query suggestions.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and search technology in general.

As described herein, in order to improve the usefulness and targeting of query recommendations, not only is the current query considered, but also the context of the query, including the set of the previous queries and/or clicked URLs that are determined to be related to the current query. For example, if the user issues a query such as “paris” (the example queries herein are not sensitive to capitalization), it is more sensible to show the user recommendations regarding the city of Paris if that user's previous searches were related to traveling, rather than provide recommendations related to any celebrity named Paris. As more specific examples, consider that a user has previously issued the query “eiffel tower” and/or clicked on http://encyl.org/xyz/france, or issued a query like “louvre museum” and/or clicked on http://www.hotels-paris.fr. When the same user later issues a query “paris” it is likely more relevant to recommend queries such as: a) “Versailles” b) “hotels in Paris France” and c) “Champs-Elysees” instead of recommended queries about a person or people. Similar scenarios apply for other ambiguous queries, e.g., “jaguar” (cars or animal), and so forth.

However, to effectively use the context of the user's query to generate query recommendations is a challenge, because not all recent queries by a user may be relevant to the current query. For example, a user may have previously issued the queries: 1) “eiffel tower” 2) “Jones” 3) “louvre museum” 4) “stock market” 5) “paris”. In this case, “Jones” and “stock market” are not relevant to the “paris” query, and thus should not be included in the context for the current query “paris”.

As another challenge, the current query, its context, and the query recommendations may not necessarily have overlapping words with one another. For instance, the current query “paris” does not share any common word with either the query “eiffel tower” in its context or the query recommendation “Versailles”.

As described herein, these challenges are handled using information about the search and clicking activities of other users, which is available from a query log (or various query logs). More particularly, as described below, this search engine query log information, which includes the queries and clicks that the engine's users have submitted over a long period of time, (e.g., one year), determines user actions that are likely related. Then, given a current query, along with a user's recent (e.g., during the last week) search activity in the form of queries and clicked URLs, the context of the current query is identified, and used to generate focused query recommendations that are relevant to this context.

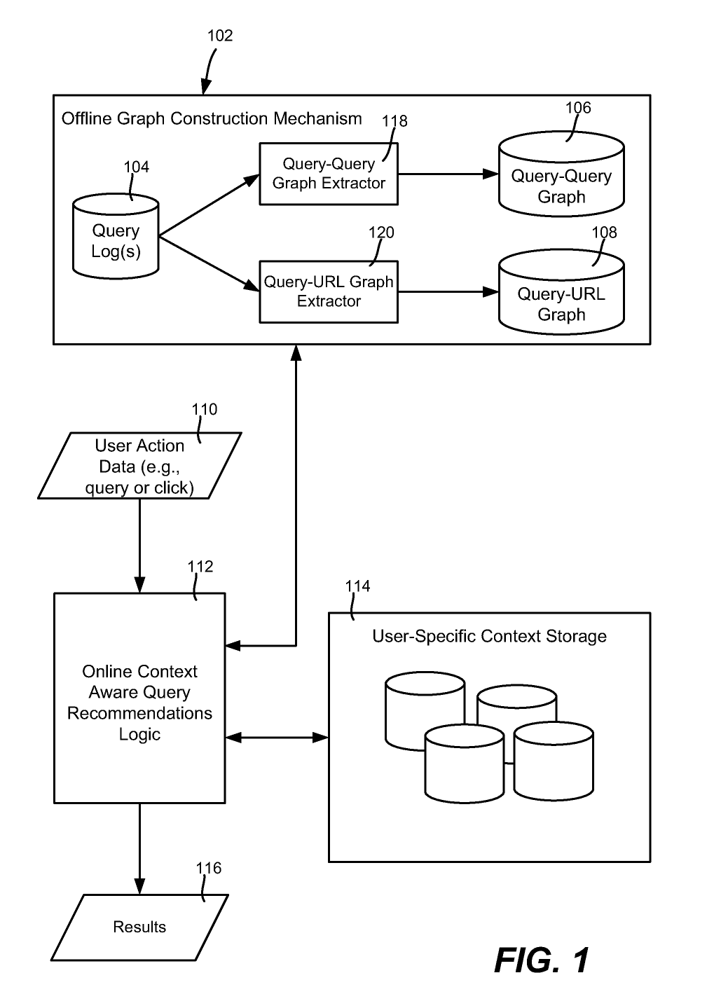

FIG. 1 shows various aspects related to generating contexts given a user's history in order to produce context-aware query recommendations. As generally represented in FIG. 1, an offline graph construction mechanism 102 processes prior query-related click information, as maintained in query logs 104 into data that may be used for determining context-aware query recommendations. As described herein, this data is maintained in a query-query graph 106 and a query-URL graph 108. In order to provide efficient access, the graphs 106 and 108 may be maintained as data stores, such as implemented in a commercially available database system or loaded into a memory in a server machine/service.

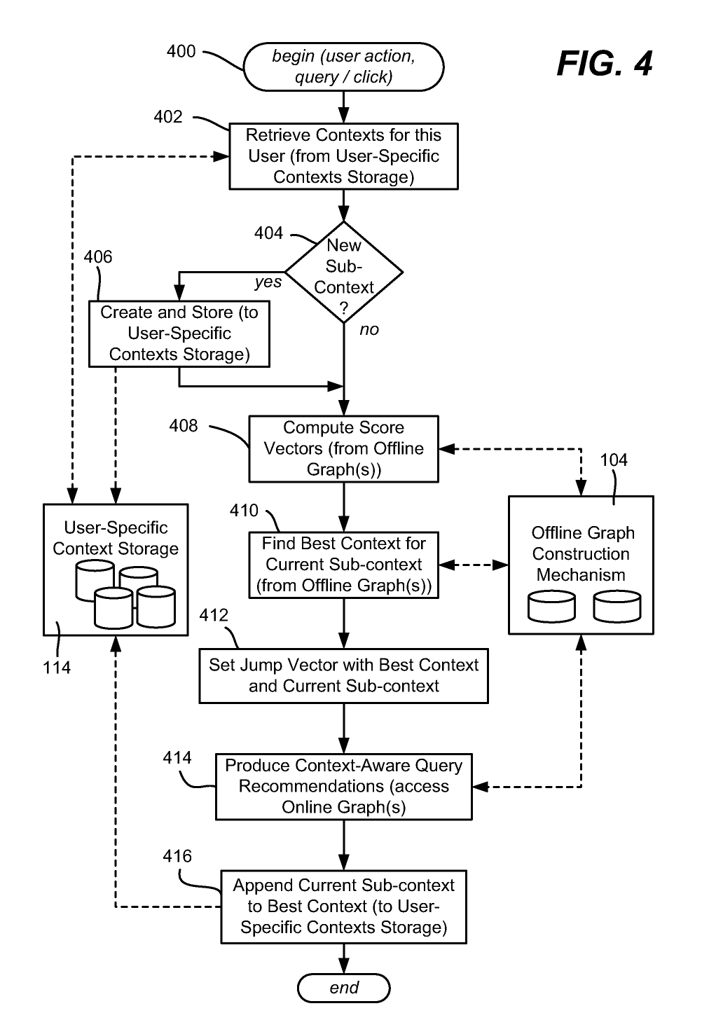

After construction, when a user action 110 such as a query or click (or possibly a hover) is received and handled by a search engine, one component or service provides online context aware query recommendations. To this end, logic 112 (as generally described below with reference to various algorithms and FIG. 4) accesses the query-query graph 106 and/or query-URL graph 108, as well as any user-specific context storage 114, to provide results 116, which may include context-aware query recommendations.

Turning to the offline generation of the graphs 106 and 108, in order to determine the possible contexts of a user's history and to recommend queries based on these contexts, the technology described herein leverages the information that is present in the query logs 104 of a search engine (e.g., www.live.com). In one implementation, these query logs 104 are collected and/or processed over a period of time (e.g., one year) to generate two graphs, namely the query-query graph 106 and the query-URL graph 108, each maintained in one or more suitable data stores. Note that in one implementation, the graphs are each constructed once, offline, and then updated as appropriate.

To construct the query-query graph 106, a query-query graph extractor 118 extracts, for each logged user, the successive query pairs from the search engine log. Each query qi is represented as a node in the graph. Each edge from q1 to q2 corresponds to the fraction of the users that issued query q2 directly after they issued q1.

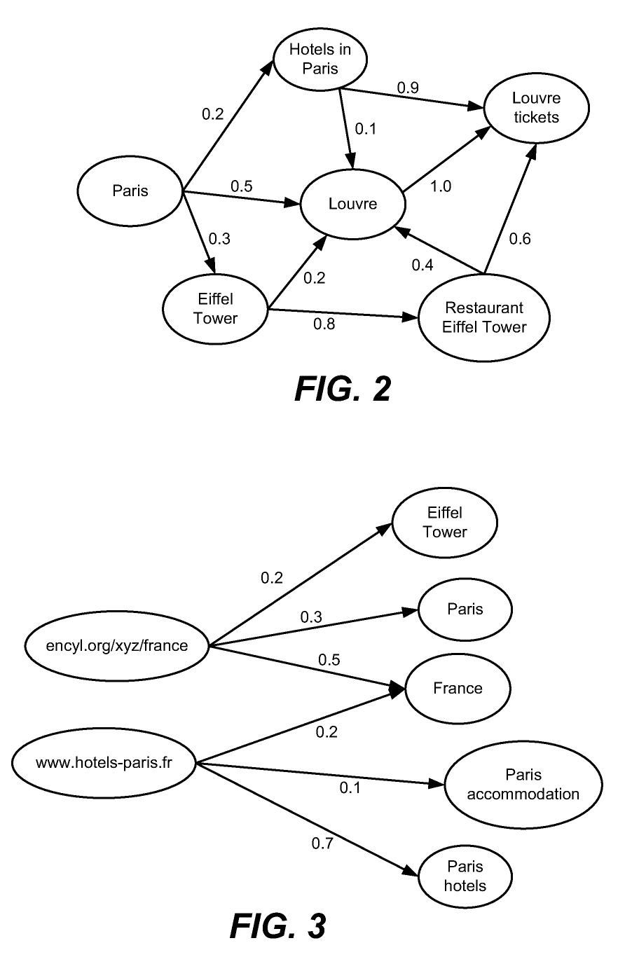

A small portion of one example of such a graph is shown in FIG. 2. In this simplified example, assuming that there are 1,000 users in total who issued the query “Eiffel tower”, 200 of them issued the query “louvre” as their next query, while 800 of them issued the query “restaurant eiffel tower” as their next query. Therefore the weights in the outgoing edges of the node corresponding to “eiffel tower” are 200/1000=0.2 and 800/1000=0.8, respectively.

One optional variation while constructing this graph that may be implemented includes dropping the outgoing edges from a node if the weight is very small (e.g., less than 0.001). This decreases the size of the graph without significantly reducing the quality of the results. Further, in one implementation, any edges with a count less than a minimum (e.g., ten) are removed, which produces a reasonably small and manageable graph without sacrificing quality.

Another option is that instead of counting the fraction of users that issued q2 directly after q1, the extractor 118 may instead count the fraction of users that issued q2 sometime after q1 (that is, not necessarily as the next query). This produces a more “connected” graph that may be helpful when the users issue rare queries; however it may slightly reduce accuracy because of finding a larger, but less specific, pool of candidate recommendations. Note that in practice, higher quality results are produced when the graph is based on the directly next query alternative.

To construct the query-URL graph 108, a query-URL graph extractor 120 extracts the queries that have resulted in a click to a given URL. In one implementation, generally represented in FIG. 3 as a small portion of such a graph, the graph includes one part (the left part) that contains the clicked URLs as nodes, and another part (the right) part that contains the queries as nodes. Edges start from a URL and end at a query; an edge from URL u to query q denotes that the URL u was clicked for the query q.

The weights on the edges denote what fraction of the time a URL u was clicked for query q. For example, assume that the URL encyl.org/xyz/france was clicked 1000 times in total, out of which 200 times it was clicked following a query for “eiffel tower.” For this URL node to query node edge, the weight is 200/1000=0.2.

An optional variation in constructing the URL-to-query graph includes the dropping of the edges that have a very small weight (e.g., less than 0.01). This tends to reduce the size of the graph without significantly reducing the precision of the results. Further, in one implementation, any edges with a count less than a minimum (e.g., ten) are removed.

Turning to another aspect, namely identifying and representing the possible contexts within the current user's history, in general, a process (e.g., in the logic 112) captures and mathematically represents the possible contexts within the user's query history. From this, the process determines the best possible (most relevant) context for the current query that the user has just provided. As used in this example, “context” comprises a set of related queries together with any clicked pages (URLs) from within the user's search history; a context may be represented as: Cᵢ={(q₁, u_{1,1}, u_{1,2}, . . . u_{1,k}), (q₂, u_{2,1} . . . ), . . . }; wherein each query (q₁-qₙ) may have zero or more URLS (e.g., u_{1,1}, u_{1,2}) associated with it. Note that the larger the index of the query, the later it comes in the user's history, that is, q₁ was submitted before q₂.

As used herein, each individual query together with any clicked URL or URLs is referred to as a sub-context. One example context (in brackets “{ }”), containing three sub-contexts (in parentheses “( )”), is {(“paris”, www.paris.com, www.paris.org), (“eiffel tower”, www.tour-eiffel.fr), (“louvre”)}.

The process defines a score vector r(S) of a sub-context S as a vector of real numbers that captures how similar S is to the rest of the query nodes in the query-query graph 106. In one implementation, the score vector of S is computed by performing a random walk in the query-query graph 106 and using the query and the clicked documents as random-jump points during the random walk. For example, given the sub-context S=(“eiffel tower”, www.tour-eiffel.fr) its score vector may look something like: (“louvre”:0.2, “louvre tickets”:0.7, “Paris”:0.1). For a more concise representation, any queries with zero scores are not included in the score vector of S.

The following sets forth one such score vector computation algorithm:

Algorithm CalculateSubcontextScoreVector

```
Input:
    The query-query graph G_{Q} (labeled 106 if FIG. 1)
    The query-URL graph G_{U} (labeled 108 if FIG. 1)
    The sub-context S = (q, u1, u2, ... uk)
    The total number of random walks numRWs ∈ [0, +∞)
    The size of the neighborhood to explore in the walk maxHops
    The damping factor d
    The importance of clicks λ_{clicks}, where 0 ≦ λ_{clicks} ≦ 1
Output:
    A score vector r(S)
Procedure:
/////////////////////////////////
// initialization steps - create the random jump vector
/////////////////////////////////
(1) foreach uᵢ ∈ S
// get all queries pointing to uᵢ together with the values on the
// respective edges
(2)  CQᵤᵢ = { (qⱼ, wⱼ) : edge(qⱼ → uᵢ) ∈G_{U} }
// merge step: merge the different CQᵤᵢ in order to create one big
// CQ_{S} that contains the information for the URLs in S
  //  if a qⱼ appears multiple times with different wⱼ, add them up
  //  if q (the query of the sub-session) appears in CQₛ, remove it
//  from merged vector
(3) CQ_{S} = UCQᵤᵢ − {(q, w_{q})}
// renormalize CQ_{S} by computing the new sum and dividing
(4) sum_{freq} = Σ_{(qi,wi)∈CQs} Wᵢ
// computation of jump vector g
(5) foreach (qᵢ , wᵢ ) ∈CQ_{S}
(6)  P(qⱼ) = wⱼ / sum_{freq}  // normalization
(7)  g_{qj} = λ_{clicks} * P(qⱼ)
// jump vector values for the queries identified from uᵢ in S
(8) g_{q} = 1 − λ_{clicks}  // jump vector value for the query q of S
// random walk computation
(9) r(S) = RandomWalk(G_{Q}, g, numRWs, maxHops) with the
following constraints:
    foreach node n visited:
        if n has no outlinks:
              stop
        if distance(n) ≧ maxHops:
              stop
        else:
            with probability d:
              pick next node to visit among n's neighbors in G_{Q}
          with probability (1−d):
                pick next node to visit among the nodes in jump
                            vector g
(10) output r(S)
END
```

The step in line (9) performs the random walk on the query-query graph. This step essentially involves a standard random walk on the graph (well-known in the art) where the random jump nodes are defined with the g parameter. The random walk can be run by representing the graph G_{Q} as an adjacency matrix and performing the iterations until convergence. An alternative approach is to use a Monte Carlo simulation for the random walk. In this case, only numRWs of the algorithm are performed, with maxHops used to limit the length of the walk away from every node.

In general the jump vector contains nodes that are important for the random walk and they bias the random walk towards the neighborhoods of these nodes in the graph. The Monte-Carlo simulation is used to save computational time, e.g., instead of computing the exact converged values of the random walk on the whole graph, a simulation is performed around the neighborhood in the graph that is of interest (where neighborhood means the user's current context as captured by the jump vector).

By way of example, assume that the query-query graph is the one shown in FIG. 2, that numRWs=1000 and that maxHops=2 and that d=0.5. If the user has currently issued the query “Paris” and the jump vector is {“paris”: 0.6, “louvre”: 0.2, “eiffel tower”:0.2}, the process operates as follows:

| | |
|---|---|
| 1. | Keep a counter for the nodes visited during the walk |
| 2. | Set current_node=”Paris” |
| 3. | Start a random walk on the graph from the current_node and keep a |
| | counter for every node that is visited |
| 4. | With probability 0.5, select an outgoing edge from the node paris as |
| | next_node, or with probability 0.5 select a node from the jump |
| | vector as next_node |
| 5. | Once it is known from where to get the next_node (from outgoing |
| | edges or jump vector), select the next node according either the |
| | weights on the edges or the weights in the jump vector. |
| | For example: |
| | If next_node is to be an outgoing edge from “paris” - select “hotels |
| | in paris”with probability 0.2, “louvre” with probability 0.5 and “eiffel |
| | tower” with probability 0.3. |
| | If next_node is from the jump vector - select “paris” as the next node |
| | with probability 0.6 and “louvre” with probability 0.2 or “eiffel |
| | tower” with probability 0.2. |
| 6. | Visit the next_node and increase its counter. |
| 7. | If more than numRWs visits, stop. |
| 8. | If more than maxHops visits away from “Paris” reset and start walk |
| | again from the node “Paris”, i.e. set as next_node=”Paris” |
| 9. | Set current_node = next_node and repeat the process from step 2 |
| | until numRWs is achieved. |
| 10. | Normalize the counters of the visited nodes to provide the output |
| | values of the random walk. They represent how important each one of |
| | the visiting nodes is for the “Paris” starting query. |

Note that in one actual implementation that uses the Monte Carlo simulation method for the random walk, an outlink with probability 0.6 is followed, and a node from the jump vector with probability 0.4 is selected; maxRWs is set to 1,000,000 and maxHops set to 3.

Once the score vectors of the sub-contexts are obtained, the process computes the score vector of the context in order to represent it mathematically. Depending on the application, the context may be represented in various ways, such as by the most (or more) recent sub-context, by the average of the sub-contexts, or by a weighted sum of the sub-contexts. The following algorithm describes the calculation of a context score vector:

Algorithm CalculateContextScoreVector

Input:

A context Cᵢ = {S₁, S₂, . . . , Sₖ}// the larger the index in Sᵢ the
more recent the

// sub-context

Representation mode m ε {RECENT, CENTROID, SUM_{recency}}

// how to represent the context

The importance of sub-context recency λ_{recency}, where 0 ≦
λ_{recency} ≦ 1

Output:

A score vector r(Cᵢ)

Procedure:
(1) if m = RECENT
(2) r(Cᵢ) = r(Sₖ) // represent the context with the score vector of the

// latest sub-context

(3) else if m = CENTROID
$( 4 ) r ( {C}_{i} ) = \frac{1}{k} {\sum }_{j = 1}^{k} r ( {S}_{i} ) // use average of score vectors of$

// sub-contexts

(5) else if m = SUM_{recency}
(6) r(Cᵢ) = (_{↓}recency Σ↓(j = 1)^{↑}k [symbol] [symbol] (1-(_{↓}recency) [symbol] ^{↑}((k − j)) r (S_{↓}j)

// weighted

// backoff model; give more weight to recent sub-context

(7) output r(Cᵢ)

Note that in one implementation λ_{recency}=1−λ_{context}. The definition of λ_{context} is generally subjective and corresponds to how aggressively context is to be taken into account.

To find the best context for a new sub-context, assume that the user is starting a new query (or a new sub-context) with zero or more clicked URLs. Before identifying potentially relevant query recommendations to the user, the process identifies which context from the user's history is the one most closely related to the current query/sub-context and therefore is to be used for the query recommendation. In one implementation, this is accomplished by computing a similarity score between the current query/sub-context and the contexts within the user's history, as set forth below:

Algorithm SelectBestContext

```
Input:
    A sub-context Sₜ = (q, u₁, ..., uₖ) // a new query with zero or
    more clicked URLs
    A set of contexts {C₁, ..., Cₘ} from where to pick the best one
    A threshold θₛᵢₘ, where 0 ≦ θₛᵢₘ ≦ 1 for the similarity function
    The importance of subcontext recency λ_{recency},
    where 0 ≦ λ_{recency} ≦ 1
    Context vector mode m ∈ { RECENT, CENTROID, SUM_{recency}}
Output:
    The best context C_{b} for the given subcontext Sₜ
Procedure:
(1) CandidateContexts = Ø
(2) r(Sₜ) = CalculateSubcontextScoreVector(Sₜ)
(3) for 1 ≦ i ≦ m
(4) r(Cᵢ) = CalculateContextScoreVector(Cᵢ, m, λ_{recency})
(5) compute simᵢ = similarity( r(Sₜ) , r(Cᵢ) )
(6) if simᵢ ≧ θₛᵢₘ
(7) CandidateContexts = CandidateContexts U (Cᵢ, simᵢ)
(8) if CandidateContexts ≠ Ø
```

| | |
|---|---|
| (9) C_{b} = Cᵢ s.t. i = argmax(simᵢ) | // pick the context with the highest |
| | // similarity |
| (10) else | |

| | |
|---|---|
| (11) C_{b} = Cₘ₊₁ | // create a new empty context because none |
| | // of the contexts is close enough |
| (12) output C_{b} | |

Any suitable similarity function may be used, such as one of the following:
Jaccard similarity on non-zero elements:

$$similarity ( r ( {S}_{t} ) , r ( {C}_{i} ) ) = \frac{\vert NZ ( r ( {S}_{t} ) ) ⋂ NZ ( r ( {C}_{i} ) ) \vert}{\vert NZ ( r ( {S}_{t} ) ) ⋃ NZ ( r ( {C}_{i} ) ) \vert} ,$$

where NZ(r(Sₜ)) are the queries from within Sₜ's score vector with a non-zero value. Similarly NZ(r(Cᵢ)) are the non-zero elements for context Cᵢ.
Kullback-Leibler similarity on non-zero elements:

$$similarity ( r ( {S}_{t} ) , r ( {C}_{i} ) ) = {\sum }_{j} \frac{{NZ}_{j} ( r ( {C}_{i} ) ) log ( {NZ}_{j} ( r ( {C}_{i} ) ) )}{{NZ}_{j} ( r ( {S}_{t} ) )} ,$$

where NZⱼ(r(Sₜ)) is the j^{th} non-zero element of r(Sₜ) and NZⱼ(r(Cᵢ)) is the j^{th} non-zero element of context r(Cᵢ).
Similarity on top X % elements of score vectors (reasonable values for X are 0.95≦X≦0.99):
   let topX(r(Sₜ)) be the top X % values of the score vector of Sₜ and define topX(r(Cᵢ)) similarly
   compute: I(r(Sₜ), r(Cᵢ))=topX(r(Sₜ))∩topX(r(Cᵢ))
   then, similarity (r(_{St}), r(_{Ci}))=f·I(r(Sₜ)r(Cᵢ)),
   where rⱼ(Sₜ) is the j^{th} top-X % element from Sₜ's score vector and rⱼ(Cᵢ) is the j^{th} top-X % element from Cᵢ's score vector, where both elements appear in I(r(Sₜ), r(Cᵢ))

To generate the context-aware query recommendations once the best possible context for a given sub-context is identified, a process (e.g., implemented in the logic 112 of FIG. 1) described below may be used. In general, one suitable approach involves identifying the best context for the user's query, setting the jump vector appropriately and performing a random walk on the query-query graph. The output of the random walk comprise the queries that are most related to the user's context, as this is captured by the random walk's jump vector. Some or all of these queries may then comprise the set of recommended queries that are returned to the user.

Algorithm CalculateQueryRecommendations

```
Input:
  A subcontext Sₜ = (q, u1, ..., uₖ) // a new query with zero or
  more clicked urls
  A set of contexts {C₁, ..., Cₘ} from where to pick the best one
  A threshold θₛᵢₘ, where 0 ≦ θₛᵢₘ ≦ 1 for the similarity function //
  reasonable values
```

//

```
  are 0.5 ≦ θₛᵢₘ ≦ 0.7
  The importance of subcontext recency λ_{recency},
  where 0 ≦ λ_{recency} ≦ 1
  The importance of context for the recommendations λ_{context},
  where 0 ≦ λ_{context} ≦ 1
  Context vector mode m ∈ { RECENT, CENTROID, SUM_{recency}}
Output:
  A score vector R_{q}(Sₜ) with recommendations
Procedure:
(1) r(Sₜ) = CalculateSubcontextScoreVector(Sₜ) // compute score
                  // vector of current sub-context
(2) C_{best} = SelectBestContext(Sₜ, {C₁, ..., Cₘ}, θₛᵢₘ, λ_{recency}, m)
(3) r(C_{best}) = CalculateContextScoreVector(C_{best}) // compute score
                    // vector for best context
(4) R_{q}(Sₜ) = (1 −λ_{context}) r(Sₜ) + λ_{context} r(C_{best})
// attach the current sub-context to the best context so that it is used
// in the future
(5) if Sₜ does not change // the user has started a new sub-
            // context, i.e., there is an Sₜ₊₁ in the system
```

| | |
|---|---|
| (6) C_{best} = append(Sₜ, C_{best}) | // attach current sub-context to |
| | // the best context |

(7) output R_{q}(Sₜ)

The output score vector R_{q}(Sₜ) contains the score values for the queries after the random walk around the context. In order to suggest the best queries to the user, the queries within R_{q}(Sₜ) may be sorted, with the top-k best queries provided as recommendations.

FIG. 4 is a flow diagram that in general summarizes the various algorithms/steps described above, beginning at step 400 where the user-provided input is received. Step 402 represents retrieving the contexts, if any exists, from the user specific context storage. Note that in general, sub-contexts may be per user session, and thus only the most recent session or sessions may be considered.

Step 404 evaluates the contexts, if any, against the user action to determine whether the input action is relevant to a new sub-context or an existing sub-context. A vector-based similarity threshold or the like may be used to determine if the action is sufficiently similar to be considered an existing sub-context, or is a new sub-context.

If new, step 406 creates and stores a new sub-context (and context if necessary) in the user specific context storage. Note that in FIG. 4, solid lines represent the flow through the various steps, whereas dashed lines represent data access operations. Note that if no existing context was found, the query recommendations may be found in the conventional way, e.g., based upon the user action itself, without context.

Step 408 represents computing the score vectors, such as via the above-described “CalculateContextScoreVector” algorithm, using the offline graphs as appropriate. In general, an offline graph is accessed to determine which query (or queries) is most similar to the user action. Step 410 represents finding the best context, such as via the above-described “SelectBestContext” algorithm, using the offline graphs as appropriate. Step 412 uses the best context and current sub-context to set the jump vector as described above.

With this information, step 414 produces the context-aware query recommendations, such as via the “CalculateQueryRecommendations” algorithm described above. These are returned to the user, which, as described above, may be after ranking and/or selecting the top recommended queries.

Step 416 appends the current sub-context for maintaining in the user-specific contexts storage 114.

As mentioned above, query recommendations may be advertisements. Other uses of query recommendations may be to automatically add or modify an existing (e.g., ambiguous) query with additional recommendation-provided data, such as to add “france” to “paris” to enhance an input query, and add, substitute or otherwise combine the results of the one or more queries (e.g., “paris”—as submitted by the user and/or “paris france”—as submitted by the system following enhancement) to provide enhanced results. Still another use is in social networking applications to match users with other users or a community based upon having similar context data.

Turning to an aspect referred to as sessionization, the process that identifies the contexts and attaches the current sub-context to the best context can also be used to perform a so-called “sessionization” of the user's history, such in an online and/or offline manner. In other words, the context changes may help detect when the user has ended one session and started another.

Sessionization involves applying the process to identify the possible contexts, which may be referred to as sessions, on the collected history of a search user over a period of time. This is useful in identifying “semantically” similar collections of related queries within a user's history and a search engine's query log, in order to study statistical properties of the user behavior and/or obtain intelligence into how the search engine is performing. For example, longer sessions may mean that users spend more time searching, and thus the recommendation service may require improvement, such as via parameter tuning and the like. In another example, if the sessions of a user are too long this may imply that he is not able to locate what she is searching for and thus the search engine may include broader topics in its search results in order to help the user.

### Exemplary Operating Environment

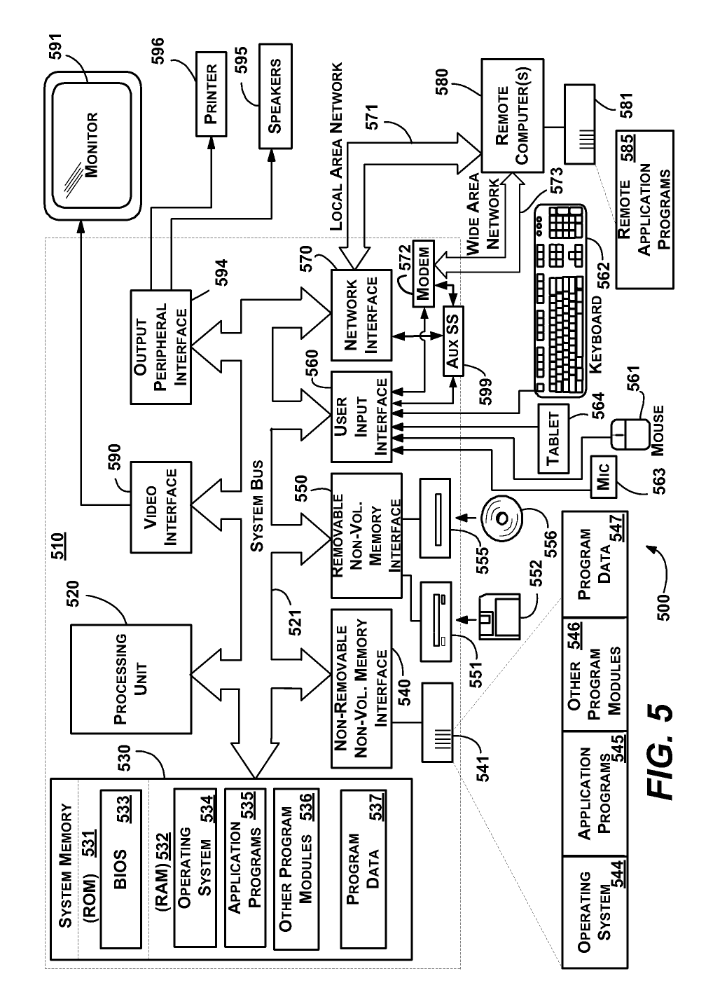

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
maintaining context information regarding prior search actions;
receiving a current action; and
accessing data obtained from a query log to determine whether at least some of the context information is relevant to the current action.

2. The method of claim 1 further comprising, at least some of the context information is relevant to the current action, and further comprising, using at least some of the context information to determine at least one query recommendation.

3. The method of claim 1 further comprising, extracting the data from the query log, including processing information in the query log into a query transition graph, and maintaining the query transition graph as at least part of the data obtained from the query log.

4. The method of claim 1 further comprising, extracting the data from the query log, including processing information in the query log into a query click graph, and maintaining the query click graph as at least part of the data extra obtained from the query log.

5. The method of claim 1 wherein accessing the data obtained from the query log comprises accessing a query transition graph to determine similarity of the current action with at least one query in the query transition graph.

6. The method of claim 1 wherein accessing the data obtained from the query log comprises accessing a query transition graph or a query click graph, or both a query transition graph and a query click graph, to determine similarity of the current action with the context information.

7. The method of claim 1 further comprising, selecting a sub-context from the context information based on similarity between the sub-context and the data obtained from the query log.

8. The method of claim 7 wherein the data obtained from the query log comprises a query transition graph, and further comprising calculating a sub-context score vector by walking through nodes of the query transition graph, and calculating a context score vector based upon the sub-context score vector.

9. The method of claim 1 further comprising using at least one parameter to control whether the context information is relevant to the current action, or using at least one parameter to control whether more recent context information is more relevant than less recent context information with respect to the current action, or using parameters to control whether the context information is relevant to the current action and whether more recent context information is more relevant than less recent context information with respect to the current action.

10. The method of claim 1 further comprising, using at least some of the context information to distinguish between sessions.

11. In a computing environment, a method comprising:
receiving a user action at a search engine;
obtaining context information maintained for the user;
computing score vectors, by accessing at least one graph containing information extracted from a query log; and
returning query recommendations based upon the score vectors.

12. The method of claim 11 further comprising, determining a most relevant context based upon the score vectors.

13. The method of claim 12 wherein returning the query recommendations based upon the score vectors comprises determining a jump vector based upon the most relevant context and a current sub-context.

14. The method of claim 11 further comprising, updating the context information based upon the most relevant context and the current sub-context.

15. The method of claim 11 further comprising, extracting the information from the query log, including processing the information in the query log into a query transition graph and a query click graph.

16. The method of claim 11 further comprising, using at least some of the context information to distinguish between sessions of a user associated with that context information.

17. One or more computer-readable media having computer-executable instructions, which when executed perform steps, comprising, extracting information from a query log into a query transition graph and a query click graph, maintaining context information, accessing the query transition graph, the query click graph and the context information to identify a relevant context for a current query or click, and providing at least one query recommendation based upon the relevant context.

18. The one or more computer-readable media of claim 17 wherein providing the at least one query recommendation comprises providing data corresponding to an advertisement.

19. The one or more computer-readable media of claim 17 having further computer-executable instructions comprising computing score vectors based upon accessing the query transition graph, the query click graph and the context information, and using the score vectors to determine similarity of the current query or click to a set of context information.

20. The one or more computer-readable media of claim 17 having further computer-executable instructions comprising, using at least some of the context information to distinguish between sessions of a user associated with that context information.
